(19) United States
(12) Patent Application Publication
(10) Pub. No.: US 2006/0190752 A1
(43) Pub. Date: Aug. 24, 2006

(54) Compensating software time in processor having sleep mode

(76) Inventor: Woon-Gwun Lee, Suwon-si (KR)

Correspondence Address: Robert E. Bushnell;Suite 300, 1522 K Street, N.W., Washington, DC, 20005-1202, US

(21) Appl. No.: 11/319,445

(22) Filed: Dec. 29, 2005

(30) Foreign Application Priority Data
Jan. 3, 2005 (KR) 2005-76

(51) Int. Cl. G06F 1/30

(52) U.S. Cl. 713/323

(57) ABSTRACT

An apparatus for and a method of compensating software time in a processor having a sleep mode includes: reading out a time value of a Real Time Clock (RTC) module upon the processor entering the sleep mode to obtain a time value immediately before the processor has entered the sleep mode; reading out a time value of the RTC module upon the processor being released from the sleep mode to obtain a time value immediately after the processor has been released from the sleep mode; and calculating a software compensation time based on the time value immediately before the processor has entered the sleep mode and the time value immediately after the processor has been released from the sleep mode.

### CLAIM OF PRIORITY

This application makes reference to, incorporates the same herein, and claims all benefits accruing under 35 U.S.C. §119 from an application for APPARATUS AND METHOD FOR COMPENSATING SOFTWARE TIME IN PROCESSOR HAVING SLEEP MODE, filed in the Korean Intellectual Property Office on Jan. 3, 2005 and there duly assigned Serial No. 2005-00076.

### BACKGROUND OF THE INVENTION

1. Field of the Invention

The present invention relates to compensating software time in a processor having a sleep mode, and more particularly, to an apparatus and method of compensating software time in a processor having a sleep mode, which enable a software clock to be compensated while a Central Processing Unit (CPU) is in a sleep mode, in order to reduce power consumption in a battery-operated terminal device such as a mobile communication terminal, a wireless LAN terminal, and the like.

2. Description of the Related Art

Computers include two clocks: a Real Time Clock (RTC) which is also called a CMOS clock or a hardware clock, and a kernel clock which is also called a software clock or a system clock. The RTC is driven by a secondary battery and continues to keep time when the computer is turned off. The kernel clock is synchronized with the CMOS clock upon initial booting of the computer system and is updated by a timer interrupt. The kernel clock is also called a software clock or a system clock. Because the two clocks proceed at a somewhat different rate, they have an increasingly larger time difference therebetween and from a correct time after a certain time period has elapsed.

Personal computers have a hardware clock which is normally driven by a mercury 11 battery or a secondary battery. Because this clock is run by the battery, it can continue to run even when the computer is turned off. The time kept by the hardware clock can be adjusted on a BIOS setup screen or through an Operating System (OS).

The hardware clock can be synchronized with a universal time or a local time. Commonly, it is convenient for the hardware clock to be synchronized with the universal time because the universal time is not adjusted for daylight savings time and thus daylight savings time need not be considered. However, PC operating systems such as MS-DOS, Windows, OS/2, and the like, often assume that the hardware clock is synchronized with the local time. Linux can have a hardware clock synchronized with the local time. In this case, it is necessary to re-synchronize the clock each time daylight savings time starts and ends.

The hardware clock is run by the battery and included as part of a microchip in a computer motherboard. It is common for the microchip to be separated from a microprocessor and other chips and to simply be called a “CMOS.” System setting values are stored in a tiny memory on the CMOS. The system setting values include current time stored by the real-time clock, and the time value is represented by the year, month, day (date and day of the week), hour, minute, and second. When the computer is turned on, a Basic Input/Output System, i.e., BIOS, stored in a Read Only Memory (ROM) of the computer reads out the current time from the real time clock and the memory in the chip.

The Linux kernel has its clock as well, which is independent from the hardware clock. That is, the kernel clock is synchronized with the hardware clock only upon booting the computer, and thereafter runs independently from the hardware clock. The reason why Linux employs its clock is that the hardware clock can run slow or malfunction.

The kernel clock (software clock) always outputs a universal time, so that the kernel need not know the local time. Such simplicity increases reliability and makes it easier to update local time information. Accordingly, respective processes are required to perform conversion to the local time by themselves.

The hardware clock and the software clock described above are not applicable only to the personal computer, but also to any devices or systems having a processor or a main processing unit such as a CPU. That is, the latest communication devices such as a mobile communication terminal, a Wireless LAN (WLAN) terminal, and the like, also include a CPU and support a sleep mode in which the CPU sleeps when it is not operating.

The CPU sleep mode causes a software time closely related to CPU operation to be incorrect. Compensation of the software time is performed differently from device to device.

A method of compensating a software time in a mobile communication terminal is described below.

When a mobile communication terminal such as a GSM terminal is in an idle mode, the method counts the number of Time Division Multiple Access (TDMA) frame interrupts generated by a baseband chip within a 4.625 ms period, and when the CPU wakes up, translates “the number of generated frame interrupts*4.625 ms” into software time units of the operating system, thereby performing compensation.

For a Code Division Multiple Access (CDMA) terminal, the method compensates the software time by translating a receive period of a paging channel sent by a base station to each terminal into software time units, i.e., ticks, of an operating system, when a main CPU remains in the sleep mode between receipt of an N-th paging frame and an (N+1)-th paging frame by the terminal, and then wakes up to receive the (N+1)-th paging frame based on the paging channel receive period.

The GSM or CDMA terminal repeatedly receives a wireless signal having a known time period. This makes it possible to measure the length of time for which the main CPU remains in the sleep mode, based on periodic frame information received from a baseband chip, even though the main CPU of the terminal does not work in the sleep mode and accordingly is unable to issue timer interrupt and update a software time of the operating system. The main CPU reads out the measured time information from the baseband chip when waking up from the sleep mode and compensates the software time of the operating system based on the measured time information.

However, when there is no signal provided by a base station or an Access Point (AP), as in a Voice over Wireless LAN (VoWLAN) terminal, the terminal is required to obtain a CPU sleeping time by itself. There is a need for an apparatus and method of compensating a software time that is widely applicable to different systems.

### SUMMARY OF THE INVENTION

It is an object of the present invention to provide an apparatus for and a method of compensating software time in a processor having a sleep mode, in which software time of an operating system is compensated by obtaining a period of time during which a main CPU does not operate to reduce power consumption, using a Real Time Clock (RTC) to provide current time.

According to one aspect of the present invention, a method of compensating software time in a processor having a sleep mode is provided, the method comprising: reading out a time value of a Real Time Clock (RTC) module upon the processor entering the sleep mode to obtain a time value immediately before the processor has entered the sleep mode; reading out a time value of the RTC module upon the processor being released from the sleep mode to obtain a time value immediately after the processor has been released from the sleep mode; and calculating a software compensation time based on the time value immediately before the processor has entered the sleep mode and the time value immediately after the processor has been released from the sleep mode.

The software compensation time is preferably calculated from a difference between the time value immediately after the processor has been released from the sleep mode and the t time value immediately before the processor has entered the sleep mode.

The method preferably further comprises obtaining the software time by adding the software compensation time to a previous software time that stopped increasing while the processor was in the sleep mode, and operating software with the software time.

The RTC module supplies a current time with a 30-microsecond resolution.

According to another aspect of the present invention, an apparatus to compensate software time in a processor having a sleep mode is provided, the apparatus comprising: a Real Time Clock (RTC) module adapted to supply a current time to the processor; a time compensation memory adapted to temporarily store the current time of the RTC module; and a controller adapted to read out a time value of an RTC module upon the processor entering the sleep mode to obtain a time value immediately before the processor has entered the sleep mode, to store the obtained time value in the time compensation memory, to read out a time value of the RTC module upon the processor being released from the sleep mode to obtain a time value immediately after the processor has been released from the sleep mode, and to calculate a software compensation time.

The controller is preferably adapted to calculate software compensation time from a difference between the obtained time value immediately after the processor has been released from the sleep mode and the obtained time value immediately before the processor has entered the sleep mode.

The RTC module preferably comprises: an RTC time register adapted to increase time data in increments of one second; and an RTC counter register adapted to increment its count 32768 times in one second.

The time compensation memory is preferably adapted to store lower 15-bit data from lower 15-bit data in the RTC counter register and upper 17-bit data from lower 17-bit data in the RTC time register.

The RTC module preferably comprises an auxiliary power source adapted to operate the RTC module even when the processor is in the sleep mode, the auxiliary power source being separate from a main power source powering the processor.

### BRIEF DESCRIPTION OF THE DRAWINGS

A more complete appreciation of the present invention, and many of the attendant advantages thereof, will be readily apparent as the present invention becomes better understood by reference to the following detailed description when considered in conjunction with the accompanying drawings, in which like reference symbols indicate the same or similar components, wherein:

FIG. 1 is a block diagram of an RTC module and a time compensation memory which are primary components of an apparatus to compensate software time according to an embodiment of the present invention;

FIG. 2 is a flowchart of a method of compensating software time according to an embodiment of the present invention; and

FIG. 3 is a view of a structure of a time compensation memory according to an embodiment of the present invention.

### DETAILED DESCRIPTION OF THE INVENTION

Hereinafter, exemplary embodiments of the present invention are described in greater detail with reference to the accompanying drawings.

The present invention is applicable to any device including a processor with a sleep mode and having no separate software compensation method. The present invention is described below using a mobile communication terminal or a wireless LAN terminal as an exemplary embodiment. Preferably, the present invention is applied to a wireless LAN terminal having no separate software compensation method.

It is common for the mobile communication terminal or the wireless LAN terminal which runs from a limited power supply, such as a battery, to have software placing an idle CPU in a sleep mode to reduce power consumption and extend battery operating time.

Terminal tasks can be largely classified into non-periodic tasks activated by a specific event such as a user key input or call reception, and periodic tasks periodically activated by a timer to maintain a terminal state.

The periodic tasks include wireless signal intensity measurement, battery voltage checks, current time display, various-indicator display, and the like. The software time managed by the operating system must be correctly maintained so that the non-periodic tasks are periodically performed at predetermined correct times.

A periodic timer interrupt, generated by a main CPU, increments the software time. However, since the main CPU does not work upon transition to the sleep mode, the main CPU cannot generate such a timer interrupt and thus cannot increment the software time.

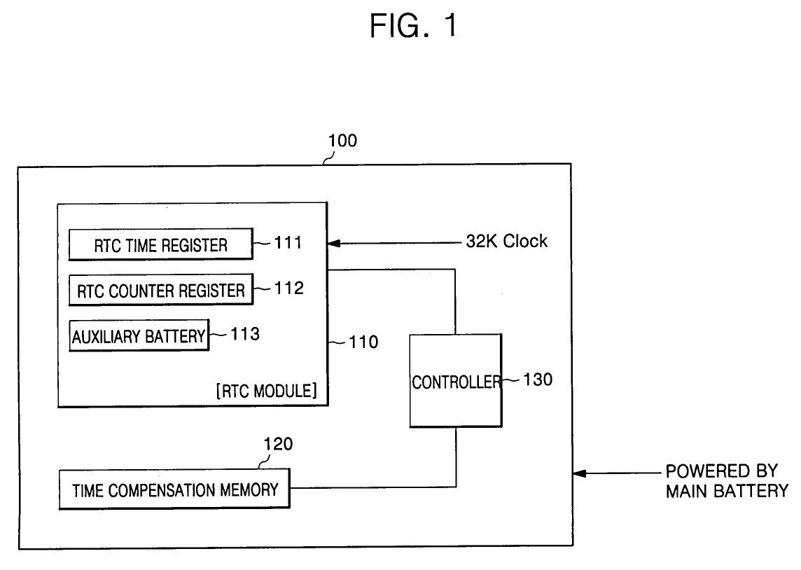

FIG. 1 is a block diagram of an RTC module and a time compensation memory which are primary components of an apparatus to compensate software time according to an embodiment of the present invention.

In the present invention, a Real Time Clock (RTC) module 110 in a Central Processing Unit (CPU) is used to compensate software time. The apparatus 100 for compensating software time according to an embodiment of the present invention includes a time compensation memory 120 and a controller 130.

A mobile communication terminal or a wireless LAN terminal has the RTC module 110 display the current time to a user. The RTC module 110 is powered by a separate auxiliary battery 113 and accordingly maintains the current time for a certain length of time without depending on a main battery of the terminal. Furthermore, the RTC module 110 is supplied with a 32.768 KHz clock, separate from a several MHz clock used by the main CPU in normal operation. The RTC module 110 counts the number of supplied clock pulses and increments the current time by “1” each time the count reaches 32768. The RTC module 110 operates independently of the CPU.

The RTC module 110 includes a register providing the current time, maintained by the RTC, which software will read out (hereinafter, RTC time register 111), and a register providing a count of RTC clock pulses that are generated starting immediately after a previous tick is incremented (hereinafter, RTC counter register 112).

Furthermore, the apparatus 100 for compensating software time according to an embodiment of the present invention has a time compensation memory 120 for storing compensation time. As described below, the time compensation memory 120 preserves part of data from the RTC time register 111 and part of data from the RTC counter register 112.

The controller 130 serves to obtain a time value immediately before the CPU enters the sleep mode by reading out a time value of the RTC module 110 of the CPU when the CPU enters the sleep mode, store the obtained time value in the time compensation memory 120, and obtains a time value immediately after the CPU wakes up by again reading out a time value of the RTC module 110 when the CPU wakes up from the sleep mode, to calculate software compensation time from the two time values.

To assist in understanding the present invention, an operation mechanism will be described in connection with a sleep mode of a CPU in a typical terminal.

There is a background task in the terminal in which a state of software in the terminal is recognized to determine whether the CPU transitions to the sleep mode. Among all of the tasks in the terminal, the background task has the lowest priority. The background task is performed only when other tasks are not being performed. Activation of the background task means that the terminal is in an idle mode in software.

The CPU supports a wait-for-interrupt mode for interrupt so that the CPU can immediately transition from the sleep mode to an operation state when a specific hardware interrupt is generated in the sleep mode. For example, a user pressing a key of a keyboard of a Personal Computer (PC) generates a keyboard interrupt which activates the CPU.

The RTC module provides an alarm function of generating a hardware interrupt at a specific time. To generate an alarm in an X-second period, a first setting is made so that the alarm is generated after X seconds have elapsed from the current time Y presented by the RTC (Y+X), and then a second setting is made at an RTC alarm interrupt handler so that an RTC alarm interrupt is generated after the X seconds have elapsed (Y+X+X). When the terminal is in the idle mode and the CPU enters the sleep mode, the CPU will wake up from the sleep mode in the X-second period through the above-described method.

As discussed above, among the terminal tasks, the activation of the background task having the lowest priority means that other terminal tasks are no longer being performed. That is, when the terminal is in the idle mode, the background task determines whether the CPU enters the sleep mode based on current conditions.

Among several conditions, the most important condition is a determination as to whether there is a task to perform for the X seconds in which the CPU is in the sleep mode. A non-periodic task, such as user key input or call reception, enables the CPU to directly wake up through hardware interrupt so that the task is normally performed. In periodic software tasks such as remaining battery power checks and wireless signal intensity measurement, each task registers a timer with a timer queue of the operating system, and when the timer has timed out, the operating system signals the task so that the task is performed at a desired time.

The timer has a time value K relative to the software time S of the operating system. When the CPU is in operation, a hardware timer interrupt generated in a period of a few milliseconds increments the time. That is, S=S+1 and K=K−1.

The timer queues of the operating system are aligned in ascending order of the relative time values (K1<K2< . . . <Kn), and accordingly, when a remaining time until the timer is timed out (K=0) is more than X seconds (K>X), the CPU enters the sleep mode and wakes up after X seconds by means of the RTC alarm interrupt. When K=X, checking of the sleep condition is repeated after a certain time delay.

Since a hardware timer interrupt for the periodic task is not generated when the CPU is in the sleep mode as described above, the software time of the operating system has the same value as immediately before the CPU enters the sleep mode. Even when the CPU wakes up after X seconds due to the RTC alarm interrupt, the software time is the same as X seconds ago. Accordingly, the software time must be compensated by a time corresponding to the X seconds for which the CPU has been in the sleep mode, so that normal tasks are performed at a scheduled time.

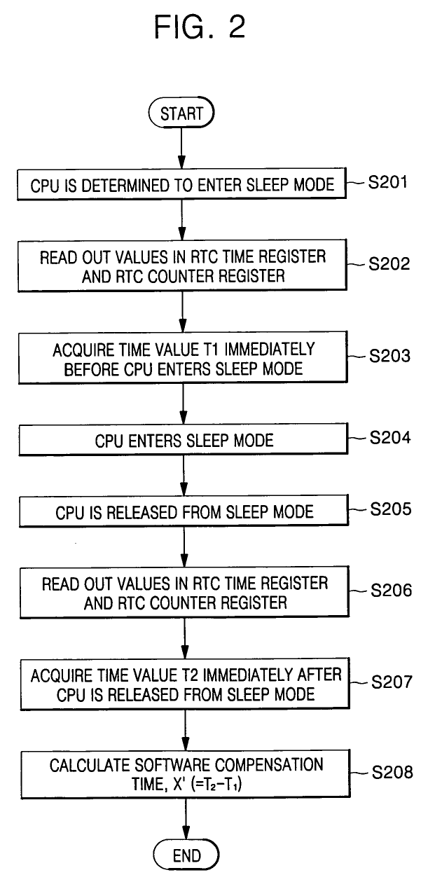

FIG. 2 is a view of a method of compensating software time according to an embodiment of the present invention.

When a CPU is determined through the above-described process to enter a sleep mode for a certain time duration (S201), e.g., X seconds in the forging example, steps for software time compensation are performed before the CPU actually enters the sleep mode.

Specifically, data in the RTC time register 111 and the RTC counter register 112 immediately before the CPU transitions to the sleep mode are read out (S202). Using the read data, a time value T1 immediately before the CPU enters the sleep mode is obtained (S203) and stored in the time compensation memory 120 of FIG. 1. That is, the lower 15 bits in the RTC counter register 112 become the lower 15 bits of the time compensation memory, and the lower 17 bits in the RTC time register 111 become the upper 17 bits of the time compensation memory. Consequently, the time compensation memory 120 stores a time value T1 immediately before the CPU transitions to the sleep mode.

After the time value immediately before the CPU enters the sleep mode has been stored, the CPU goes into the sleep mode for a certain time period (S204), and wakes up when the certain time period has elapsed (S205).

At this time, i.e., when the CPU transitions from the sleep mode to a normal operation mode, the CPU again reads out the values stored in the RTC time register 111 and the RTC counter register 112 (S206) and obtains a time value T2 at a time when the CPU wakes up from the sleep mode (S207). The CPU calculates a time X′(=T2−T1) for which the CPU has been in the sleep mode by subtracting the time value T1 stored when the CPU entered the sleep mode from T2 (S208).

The thus obtained time is translated into the software time of the operating system (S=S+X′), thereby performing time compensation. That is, a previous software time that stops increasing during the sleep time plus the software compensation time becomes the software time at which the software begins to operate. As a result, the software time normally proceeds while the CPU is in the sleep mode and all software in the terminal becomes able to proceed according to their schedule without being affected by the CPU sleep mode.

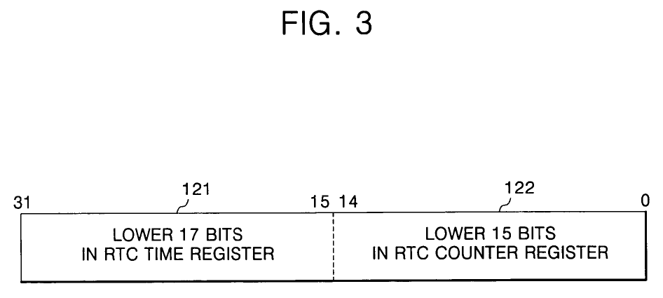

FIG. 3 is a view of a structure of the time compensation memory according to an embodiment of the present invention.

A clock used in calculation for software time compensation according to the present invention stores the lower 17 bits of the value in the RTC time register 111 and the lower 15 bits of the value in the RTC counter register 112 as 32-bit data as shown in FIG. 3. That is, the lower 15 bits in the RTC counter register 112 become the lower 15 bits 122 of the time compensation memory 120, and the lower 17 bits of the RTC time register 111 become the upper 17 bits 121 of the time compensation memory 120.

The 15-bit value of the RTC counter register 112 is incremented 32768 (=215) times a second and accordingly is incremented by “1” at each approximately 30 μs. The value of the RTX time register 111 is incremented by “1” each time the value of the RTC counter register 112 is incremented 32768 times. That is, the time compensation memory 120 including the values of the RTC time register 111 and the RTC counter register 112 has a capability of storing a time value on a 30-microsecond basis. This makes it possible to compensate the software time of the operating system with a 30-microsecond resolution using the apparatus and method of compensating software time according to an embodiment of the present invention.

With a power saving method according to the present invention, it is possible to perform a periodic task at a prescribed time even when a transition between a sleep mode and a waking mode is repeated in a CPU.

According to the present invention, a time value immediately before a CPU enters a sleep mode and a time value when the CPU wakes up from the sleep mode are obtained using a feature of an RTC module in which the current time is maintained even when a processor is in a sleep mode, and virtual time used by an operating system is compensated using the obtained time values such that the software cannot recognize whether the CPU has been in the sleep mode. Thus, non-periodic tasks in the CPU can be correctly performed without being affected by a mode of the CPU.

While the present invention has been described with reference to exemplary embodiments thereof, it will be understood by those skilled in the art that various modifications in form and detail can be made therein without departing from the scope of the present invention as defined by the following claims.

What is claimed is:

1. A method of compensating software time in a processor having a sleep mode, the method comprising:
reading out a time value of a Real Time Clock (RTC) module upon the processor entering the sleep mode to obtain a time value immediately before the processor has entered the sleep mode;
reading out a time value of the RTC module upon the processor being released from the sleep mode to obtain a time value immediately after the processor has been released from the sleep mode; and
calculating a software compensation time based on the time value immediately before the processor has entered the sleep mode and the time value immediately after the processor has been released from the sleep mode.

2. The method according to claim 1, wherein the software compensation time is calculated from a difference between the time value immediately after the processor has been released from the sleep mode and the time value immediately before the processor has entered the sleep mode.

3. The method according to claim 1, further comprising obtaining the software time by adding the software compensation time to a previous software time that stopped increasing while the processor was in the sleep mode, and operating software with the software time.

4. The method according to claim 1, wherein the RTC module supplies a current time with a 30-microsecond resolution.

5. An apparatus to compensate software time in a processor having a sleep mode, the apparatus comprising:
a Real Time Clock (RTC) module adapted to supply a current time to the processor;
a time compensation memory adapted to temporarily store the current time of the RTC module; and
a controller adapted to read out a time value of an RTC module upon the processor entering the sleep mode to obtain a time value immediately before the processor has entered the sleep mode, to store the obtained time value in the time compensation memory, to read out a time value of the RTC module upon the processor being released from the sleep mode to obtain a time value immediately after the processor has been released from the sleep mode, and to calculate a software compensation time.

6. The apparatus according to claim 5, wherein the controller is adapted to calculate software compensation time from a difference between the obtained time value immediately after the processor has been released from the sleep mode and the obtained time value immediately before the processor has entered the sleep mode.

7. The apparatus according to claim 5, wherein the RTC module comprises:
an RTC time register adapted to increase time data in increments of one second; and
an RTC counter register adapted to increment its count 32768 times in one second.

8. The apparatus according to claim 7, wherein the time compensation memory is adapted to store lower 15-bit data from lower 15-bit data in the RTC counter register and upper 17-bit data from lower 17-bit data in the RTC time register.

9. The apparatus according to claim 5, wherein the RTC module comprises an auxiliary power source adapted to operate the RTC module even when the processor is in the sleep mode, the auxiliary power source being separate from a main power source powering the processor.
